(19) United States
(12) Patent Application Publication
(10) Pub. No.: US 2026/0074975 A1
(43) Pub. Date: Mar. 12, 2026

(54) APPLICATION METHOD FOR APPLICATION FUNCTION AND DEVICE

(71) Applicant: BEIJING XIAOMI MOBILE SOFTWARE CO., LTD., Beijing (CN)

(72) Inventors: Dong CHEN, Beijing (CN); Yuze SUN, Beijing (CN)

(73) Assignee: BEIJING XIAOMI MOBILE SOFTWARE CO., LTD., Beijing (CN)

(21) Appl. No.: 19/100,812

(22) PCT Filed: Aug. 5, 2022
(86) PCT No.: PCT/CN2022/110707

§ 371 Date: Feb. 3, 2025

(51) Int. Cl. H04L 43/0817; H04W 84/04

(52) U.S. Cl. CPC H04L 43/0817; H04W 84/042

(57) ABSTRACT

An application method for an application function includes: receiving, by an application repository function (APRF), an application function (AF) calling request sent by a first network function (NF), in which, the calling request includes a first type identifier of an AF to be used; traversing, by the APRF, a preset AF data table based on the first type identifier, wherein the AF data table stores description information of available AFs; and sending, by the APRF, description information of a first AF to the first NF in response to the description information of the first AF in the AF data table comprising the first type identifier.

### CROSS-REFERENCE TO RELATED APPLICATION

This application is a U.S. national phase of International Application No. PCT/CN2022/110707, filed Aug. 5, 2022, the entire content of which is incorporated herein by reference for all purposes.

### TECHNICAL FIELD

The disclosure relates to the field of communication technologies, in particular to an application method for an application function and a device.

### BACKGROUND

With development of mobile communications, future network functions will not only include control plane functions, but also data plane functions (that is, application functions), such as an application function that provides a sensing capability and an application function that provides computing power.

### SUMMARY

According to a first aspect, an application method for an application function in one or more examples of the disclosure is provided. The method is performed by an application repository function (APRF), and includes: receiving an application function (AF) calling request sent by a first network function (NF), in which, the calling request includes a first type identifier of an AF to be used; traversing a preset AF data table based on the first type identifier, in which, the AF data table stores description information of available AFs; and sending description information of a first AF to the first NF in response to the description information of the first AF in the AF data table comprising the first type identifier.

According to a second aspect, an application method for an application function in one or more examples of the disclosure is provided. The method is performed by a network function (NF), and includes: sending an application function (AF) calling request to an application repository function (APRF), in which the calling request includes a first type identifier of an AF to be used; receiving description information of a first AF sent by the APRF; and sending a calling request to the first AF based on description information of the first AF.

According to a third aspect, an application method for an application function in one or more examples of the disclosure is provided. The method is performed by an application function (AF), and includes: receiving a calling request sent by a network function (NF), in which, the calling request is generated by the NF based on description information of an AF sent by an application repository function (APRF), and the calling request includes an instance identifier of an AF to be used; and providing to the NF an AF service corresponding to an instance identifier of the AF.

### BRIEF DESCRIPTION OF THE DRAWINGS

In order to more clearly illustrate the technical solution in one or more examples of the disclosure or the background, the accompanying drawings to be used in embodiments of the disclosure or the background will be described below.

FIG. 1 is a structural diagram of a communication system according to an example of the disclosure.

FIG. 2 is a flowchart of an application method for an application function provided by an example of the disclosure.

FIG. 3 is a flowchart of another application method for an application function provided by an example of the disclosure.

FIG. 4 is a flowchart of another application method for an application function provided by an example of the disclosure.

FIG. 5 is a flowchart of another application method for an application function provided by an example of the disclosure.

FIG. 6 is a flowchart of another application method for an application function provided by an example of the disclosure.

FIG. 7 is a flowchart of yet another application method for an application function provided by an example of the disclosure.

FIG. 8 is a schematic diagram of interaction of yet another application method for an application function provided by an example of the disclosure.

FIG. 9 is a schematic diagram of interaction of yet another application method for an application function provided by an example of the disclosure.

FIG. 10 is a schematic diagram of interaction of yet another application method for an application function provided by an example of the disclosure.

FIG. 11 is a schematic diagram of a communication device provided by an example of the disclosure.

FIG. 12 is a schematic diagram of another communication device provided by an example of the disclosure.

FIG. 13 is a schematic diagram of a chip provided by an example of the disclosure.

### DETAILED DESCRIPTION

To facilitate understanding, terms involved in the present disclosure are first introduced.

### 1. Application Function (AF)

The AF is a network element that provides data plane functions for a network element in the network, such as providing sensing capability, computing power, etc.

### 2. Network Function (NF)

The NF is a network element that discovers and uses the AF in the network for data processing.

### 3. Application Repository Function (APRF)

The APRF is a network element used to register application functions in the network.

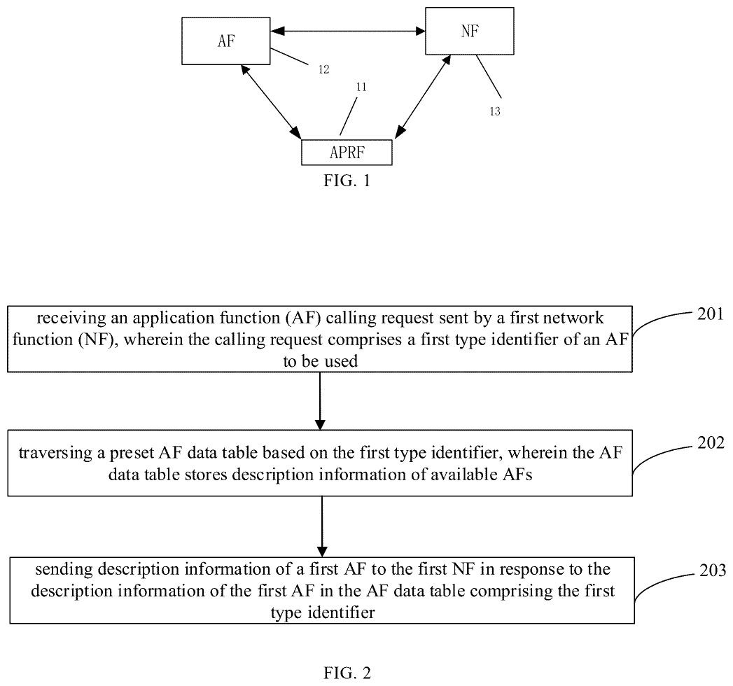

Please refer to FIG. 1, FIG. 1 is a structural diagram of a communication system according to an example of the disclosure. The communication system may include, but is not limited to, one APRF, one AF and one NF. The number and form of devices shown in FIG. 1 are only for examples and do not constitute a limitation on examples of the present disclosure. In actual applications, the communication system may include two or more AFs, and two or more NFs. The communication system shown in FIG. 1 includes an APRF 11, an AF 12 and an NF 13 as an example.

It is to be noted that the technical solution of examples of the present disclosure can be applied for various communication systems, for example, a long-term evolution (LTE) system, a 5th generation (5G) mobile communication system, a 5G new radio (NR) system, or other future new mobile communication systems.

The APRF 11, the AF 12 and the NF 13, respectively in an example of the present disclosure are an entity for transmitting or receiving signals in a core network. Embodiments of the present disclosure do not limit the specific technologies and specific equipment forms used by each network element.

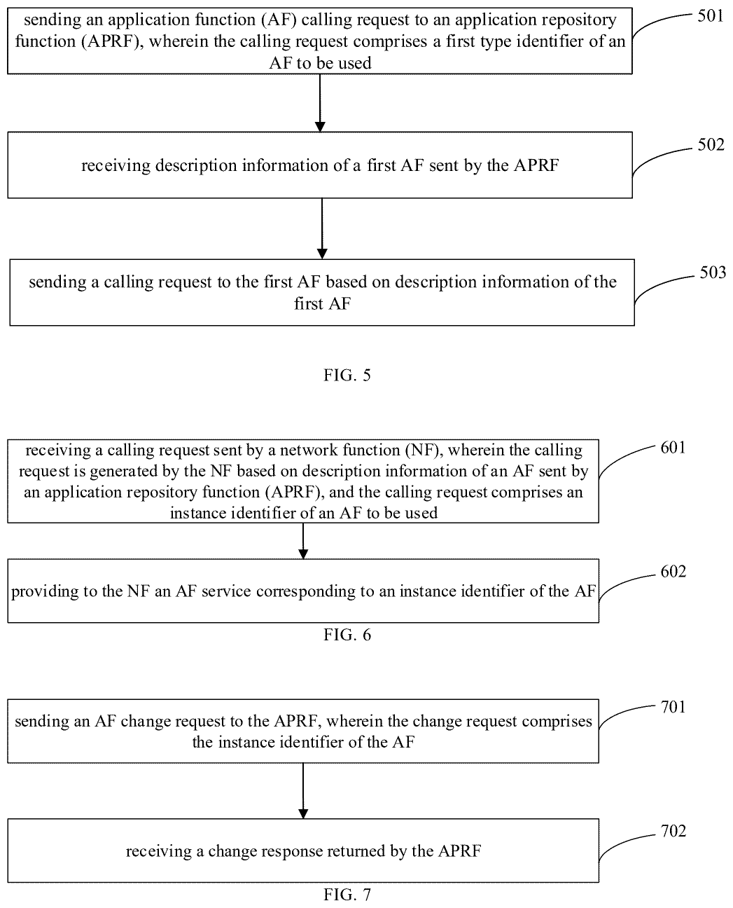

In this system, the APRF may implement the method of any example shown in FIG. 2 to FIG. 4 of the disclosure, the AF may implement the method of the example shown in FIG. 5 of the disclosure, and NF may implement the method of any example shown in FIG. 6 to FIG. 7 of the disclosure

It is to be understood that the communication system described in examples of the present disclosure is to more clearly illustrate the technical solution of embodiments of the present disclosure, and does not constitute a limitation on the technical solution provided by examples of the present disclosure. Those ordinary skilled in the art know that, with evolution of system architecture and emergence of new business scenarios, the technical solution provided by examples of the present disclosure are also applicable for similar technical problems.

The present disclosure proposes an application method of an application function. An AF performs AF registration to an APRF, so that the APRF knows a service type that can be provided by the AF and notifies other NFs of discovery and use, resulting in that each AF can be reliably discovered and called, performance of the communication system can be improved.

Please refer to FIG. 2, FIG. 2 is a flowchart of an application method for an application function provided by an example of the disclosure. The method is performed by an APRF. As shown in FIG. 2, the method may include, but is not limited to, following steps.

At step 201, an AF calling request sent by a first NF is received, in which, the calling request includes a first type identifier of an AF to be used.

The type identifier is configured to describe a type of a function provided by an AF. For example, the function provided by the AF may be a computing power type or a sensing capability type, etc.

In this disclosure, when the NF desires to use the AF, the NF may send the AN calling request to the APRF. For example, when the NF has a computing power demand, the NF may send the AF calling request including the computing power type to the APRF.

At step 202, a preset AF data table is traversed based on the first type identifier, in which, the AF data table stores description information of available AFs.

In the present disclosure, the APRF may maintain a data table including description information of each available AF. The available AF is an AF that can be used by each NF, that is, an AF that has been registered with the APRF and has not been deregistered.

Optionally, the description information of the AF may include at least one of: a type identifier, an instance identifier, a public land mobile network (PLMN) identifier, a network slice identifier, a network address or provided function service information of the AF.

The instance identifier is an identifier that can uniquely identify a certain application function in a certain AF. The function service information is detailed description information of the application function, such as a scale of computing power that can be provided, etc. The PLMN identifier, the network slice identifier, the network address, etc., may be configured to determine the AF where the application function is.

For example, if AF element A can provide both computing power and a sensing capability, the APRF is to be provided in the preset AF data table, that is, stores a PLMN identifier, a network slice identifier, and a network address, etc., of the AF element A, to locate the AF element A, and also stores the type identifier and the instance identifier of the AF that can be provided.

At step 203, description information of a first AF is sent to the first NF in response to the description information of the first AF in the AF data table comprising the first type identifier.

Optionally, in response to description information of each AF in the AF data table not including the first type identifier, an AF calling failure indication is returned to the first NF.

That is, the APRF stores the description information of the available AFs. After receiving the AF calling request sent by the first NF, the APRF may traverse the preset AF data table based on the first type identifier of the AF to be used. If the description information of the first AF in the data table includes the first type identifier, it indicates that the first AF meets an NF requirement, and the description information of the first AF may be sent to the first NF, so that the first NF may call the corresponding function in the first AF based on the description information of the first AF. Alternatively, if the description information of each AF in the data table does not include the first type identifier, it indicates that there is currently no available AF that meets the NF requirement, and the calling failure indication may be returned to the first NF.

In this disclosure, after receiving the AF calling request sent by the first NF, the APRF first traverses the preset AF data table based on the first type identifier of the AF to be used, and sends the description information of the first AF to the first NF in a case of determining that the description information of the first AF in the data table includes the first type identifier,. Therefore, the NF can reliably discover and use the AF, and performance of a communication system may be improved.

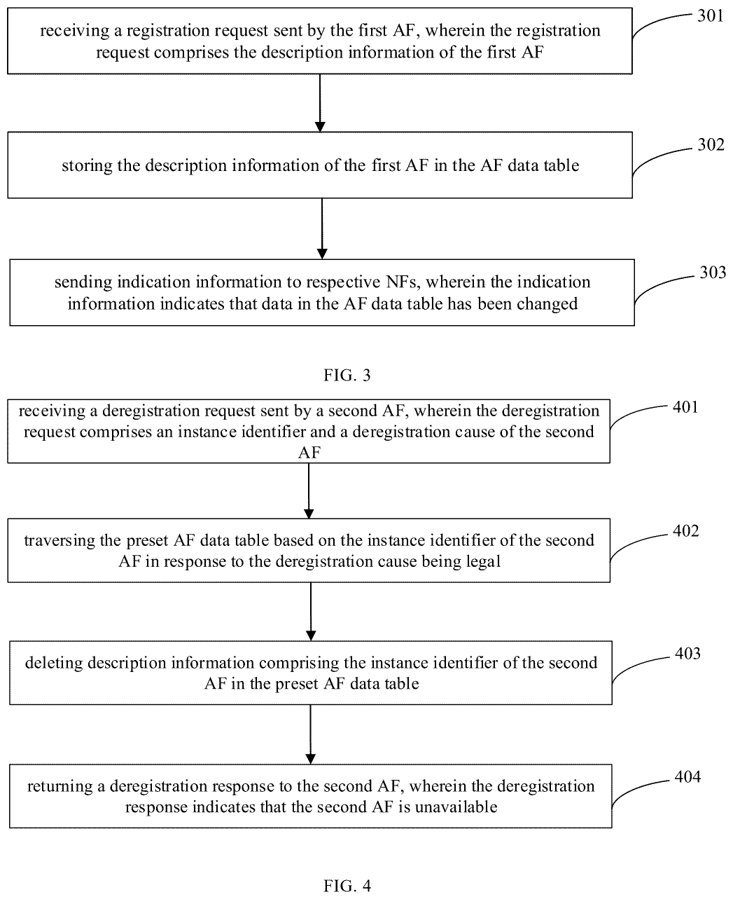

Please refer to FIG. 3, FIG. 3 is a flowchart of another application method for an application function provided by an example of the disclosure. The method is performed by an APRF. As shown in FIG. 3, the method may include, but is not limited to, following steps.

At step 301, a registration request sent by the first AF is received, in which, the registration request includes the description information of the first AF.

The description information of the AF may refer to detailed description of any example of the present disclosure, and will not be described again herein.

In this disclosure, in a case that the first AF newly joins the network, or in a case that a new application function is added to the first AF, the registration request may be sent to the APRF, to synchronize to the APRF the application function that can be provided.

At step 302, the description information of the first AF is stored in the AF data table.

In this disclosure, after receiving the registration request sent by the AF, the APRF may store the received description information of the first AF into the AF data table, such that, when the NF has a use requirement later, the APRF may determine whether an application function that meet the requirement is present by querying the AF data table.

Optionally, the APRF may also return a registration response to the first AF, in which, the registration response indicate that registration of the first AF is completed.

At step 303, indication information is sent to respective NFs, in which, the indication information indicates that data in the AF data table has been changed.

In this disclosure, in a case that the description information of a new application function is stored in the AF data table, the APRF may indicate to each NF that the AF data table has changed, thereby assisting the NF in discovering the new application function.

Optionally, the indication information sent by the APRF may indicate the number of AFs currently included in the AF data table; or may explicitly indicate that the AF data table has been changed. For example, a specific bit with a value set as 1 indicates that the AF data table has been changed. The disclosure does not limit this.

Optionally, the APRF may also send the updated AF data table to each NF, such that each NF may directly determine each available AF based on the data table, and then when calling is required, the corresponding AF may be directly called based on the data table. The disclosure does not limit this.

In this disclosure, after receiving the registration request sent by the first AF, the APRF may store the description information of the first AF into the preset AF data table, and send the indication information indicating that the AF data table has been changed to the NF. Therefore, the NF may reliably discover and use the AF, and performance of the communication system may be improved.

Please refer to FIG. 4, FIG. 4 is a flowchart of another application method for an application function provided by an example of the disclosure. The method is performed by an APRF. As shown in FIG. 4, the method may include, but is not limited to, following steps.

At step 401, a deregistration request sent by a second AF is received, in which, the deregistration request includes an instance identifier and a deregistration cause of the second AF.

The instance identifier of the second AF is used by APRF to uniquely determine the second AF from the preset AF data table.

Optionally, in order to prevent the second AF from being maliciously deregistered, the deregistration request may also include the deregistration cause to represent a cause why the second AF exits the network.

In this disclosure, when the AF cannot continue to provide the application function, the AF can also send the deregistration request to the APRF to synchronize its status to the APRF.

At step 402, the preset AF data table is traversed based on the instance identifier of the second AF in response to the deregistration cause being legal.

At step 403, description information including the instance identifier of the second AF in the preset AF data table is deleted.

At step 404, a deregistration response is returned to the second AF, in which, the deregistration response indicates that the second AF is unavailable.

In a case that the APRF receives the deregistration request sent by the second AF and determines that the deregistration cause is legal, the APRF may delete the description information including the instance identifier of the second AF in the preset AF data table, that is, determine that the application function of the second AF is unavailable. Afterwards, in a case that a calling request for calling the second AF sent by the NF is received again, a calling failure message may

Optionally, the APRF may also send the indication information to each NF after deleting the description information of a certain AF in the preset AF data table to indicate that data in the AF data table has changed.

It is to be noted that if the APRF determines that the deregistration cause is illegal, the APRF may also return a deregistration failure response to the second AF and indicate the cause indicating the deregistration failure in the deregistration failure response. The disclosure does not limit this.

In this disclosure, after receiving the deregistration request sent by the second AF, the APRF may delete the description information including the instance identifier of the second AF from the preset AF data table, and return the deregistration message to the second AF, to indicate that the second AF has been unavailable. Therefore, the NF may reliably discover and use the AF, and performance of the communication system may be improved.

Please refer to FIG. 5, FIG. 5 is a flowchart of yet another application method for an application function provided by an example of the disclosure. The method is performed by an NF. As shown in FIG. 5, the method may include, but is not limited to, following steps.

At step 501, an AF calling request is sent to an APRF, in which, the calling request includes a first type identifier of an AF to be used.

In this disclosure, in a case that the NF needs to use the application function, the NF first needs to determine a type of the application function to be used, and then may send the AF calling request to the APRF. For example, the NF desires to use an application function with a computing power type, the NF may send the calling request including a computing power type identifier to the APRF to indicate to the APRF that the NF desires to use the application function with the computing power type.

At step 502, description information of a first AF sent by the APRF is received.

Optionally, the description information of the AF may include at least one of: a type identifier, an instance identifier, a public land mobile network (PLMN) identifier, a network slice identifier, a network address or provided function service information of the AF.

The instance identifier is an identifier that can uniquely identify a certain application function in a certain AF. The function service information is detailed description information of the application function, such as a scale of computing power that can be provided, etc. The PLMN identifier, the network slice identifier, the network address, etc., may be configured to determine the AF where the application function is.

For example, if AF element A can provide both computing power and a sensing capability, the APRF is to be provided in the preset AF data table, that is, stores a PLMN identifier, a network slice identifier, and a network address, etc., of the AF element A, to locate the AF element A, and also stores the type identifier and the instance identifier of the AF that can be provided.

At step 503, a calling request is sent to the first AF based on description information of the first AF.

After receiving the description information of the first AF, the NF may send the calling request to the first AF based on the PLMN identifier, the network slice identifier, the network address, etc., of the first AF.

Optionally, an AF calling failure indication sent by the APRF is received That is, after the NF sends the AF calling request to the APRF, if the APRF does not query a matching AF in the stored preset AF data table, the APRF may return the AF calling failure indication to the NF.

Optionally, indication information sent by the APRF is received, in which, the indication information indicates that data in an AF data table in the APRF has been changed.

The indication information sent by the APRF may indicate the number of AFs currently included in the AF data table; or may explicitly indicate that the AF data table has been changed. For example, a specific bit with a value set as 1 indicates that the AF data table has been changed. The disclosure does not limit this.

Optionally, the APRF may also send the updated AF data table to each NF, such that each NF may directly determine each available AF based on the data table, and then when calling is required, the corresponding AF may be directly called based on the data table. The disclosure does not limit this.

In this disclosure, the NF may send the AF calling request to the APRF, and send the calling request to the first AF based on the description information of the first AF after receiving the description information of the first AF sent by the APRF. Therefore, the NF can reliably discover and use the AF, and performance of a communication system may be improved.

Please refer to FIG. 6, FIG. 6 is a flowchart of yet another application method for an application function provided by an example of the disclosure. The method is performed by an AF. As shown in FIG. 6, the method may include, but is not limited to, following steps.

At step 601, a calling request sent by a network function (NF) is received, in which, the calling request is generated by the NF based on description information of an AF sent by an application repository function (APRF), and the calling request includes an instance identifier of an AF to be used.

The instance identifier of the AF is an identifier that can uniquely identify a certain application function in the AF.

Since the AF may provide a plurality of application functions, when the NF needs to use a certain application function, it is required to carry the instance identifier of the application function. Therefore, the AF may determine a target AF requested by the NF based on the instance identifier of the AF.

At step 602, an AF service corresponding to an instance identifier of the AF is provided to the NF.

In this disclosure, in response to the AF receiving the calling request sent by the NF, the AF may provide the application function service corresponding to the instance identifier of the AF requested by the NF.

In this disclosure, the AF may provide to the NF the corresponding AF service based on the instance identifier of the AF in the request after receiving the application function calling request sent by the NF. Therefore, the NF can reliably discover and use the AF, and performance of a communication system may be improved.

Please refer to FIG. 7, FIG. 7 is a flowchart of yet another application method for an application function provided by an example of the disclosure. The method is performed by an AF. As shown in FIG. 7, the method may include, but is not limited to, following steps.

At step 701, an AF change request is sent to the APRF, in which, the change request includes the instance identifier of the AF.

The instance identifier of the AF is used by the APRF to uniquely determine a second AF from a preset AF data table.

Optionally, the change request is a registration request, and the registration request further includes a type identifier, a public land mobile network (PLMN) identifier, a network slice identifier, a network address and provided function service information of the AF.

That is, in a case that the AF newly joins the network, or in a case that a new application function is added to the AF, the registration request may be sent to the APRF, to synchronize to the APRF the application function that can be provided.

Optionally, the change request is a deregistration request, and the deregistration request further includes a deregistration cause.

That is, when the AF cannot continue to provide the application function, the AF can also send the deregistration request to the APRF to synchronize its status to the APRF.

Optionally, in order to prevent the second AF from being maliciously deregistered, the deregistration request may also include the deregistration cause to represent a cause why the second AF exits the network.

At step 702, a change response returned by the APRF is received.

That is, the APRF may return a registration response to the AF in a case of receiving the registration request sent by the AF, to indicate success or failure of registration; or, the APRF may also return the deregistration response to the AF in a case of receiving the deregistration request sent by the AF, to indicate that the AF is unavailable.

In this disclosure, the AF may send the AF change request to the APRF in a case that the application function that can be provided is changed. Therefore, the NF may reliably discover and use the AF, and performance of the communication system may be improved.

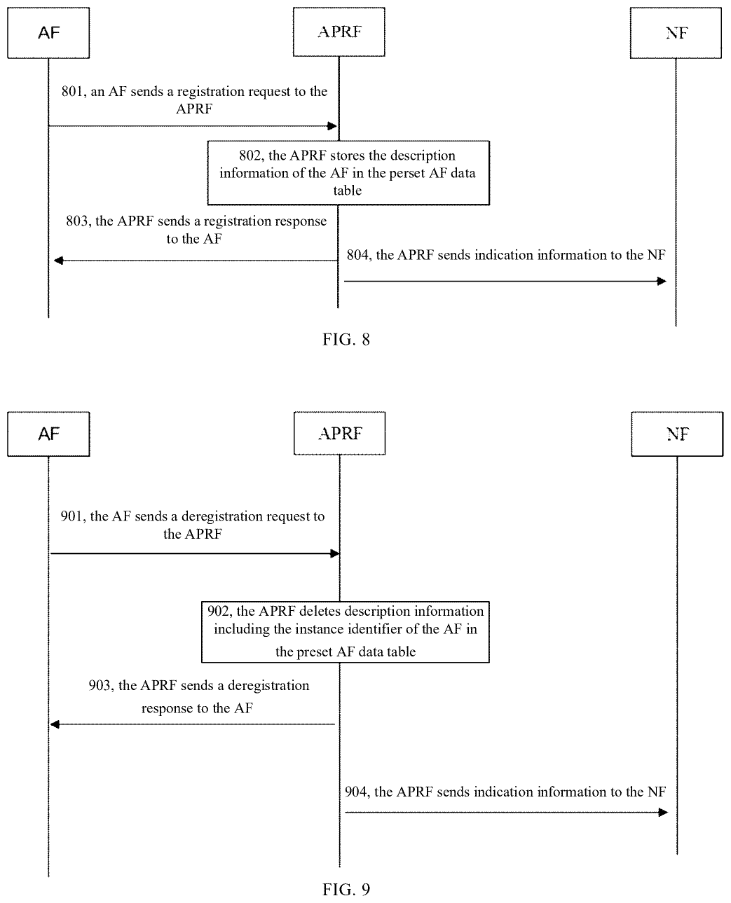

FIG. 8 is a schematic diagram of interaction of an application method for an application function provided by an example of the disclosure. The method is performed by a core network device. As shown in FIG. 8, the method may include, but is not limited to, following steps.

At step 801, an AF sends a registration request to the APRF.

The registration request includes the description information of the AF.

At step 802, the APRF stores the description information of the AF in the perset AF data table.

At step 803, the APRF sends a registration response to the AF.

At step 804, the APRF sends indication information to the NF, in which, the indication information indicates that data in the AF data table has been changed.

The step 804 may be executed synchronously with step 803 or before step 803, and this disclosure does not limit this. In addition, for a specific implementation process of each of the above steps, reference may be made to detailed description of any example of the present disclosure from FIG. 1 to FIG. 7, which will not be described again herein.

In this disclosure, the AF may send the registration request to the APRF, and then the APRF may store the description information of the AF in the preset AF data table and notify the NF of discovering and using the AF. Therefore, the NF may reliably discover and use the AF, and performance of the communication system may be improved.

FIG. 9 is a schematic diagram of interaction of another application method for an application function provided by an example of the disclosure. As shown in FIG. 9, the method may include, but is not limited to, following steps.

At step 901, the AF sends a deregistration request to the APRF.

The deregistration request includes an instance identifier and a deregistration cause of the AF.

At step 902, the APRF deletes description information including the instance identifier of the AF in the preset AF data table.

At step 903, the APRF sends a deregistration response to the AF.

At step 904, the APRF sends indication information to the NF.

The indication information indicates that data in the AF data table has been changed. The step 904 may be executed synchronously with step 903 or before step 903, and this disclosure does not limit this. In addition, for a specific implementation process of each of the above steps, reference may be made to detailed description of any example of the present disclosure from FIG. 1 to FIG. 7, which will not be described again herein.

In this disclosure, the AF may send the deregistration request to the APRF, and then the APRF may delete the description information of the AF from the preset AF data table and notify the NF of discovering and applying the AF. Therefore, the NF may reliably discover and use the AF, and performance of the communication system may be improved.

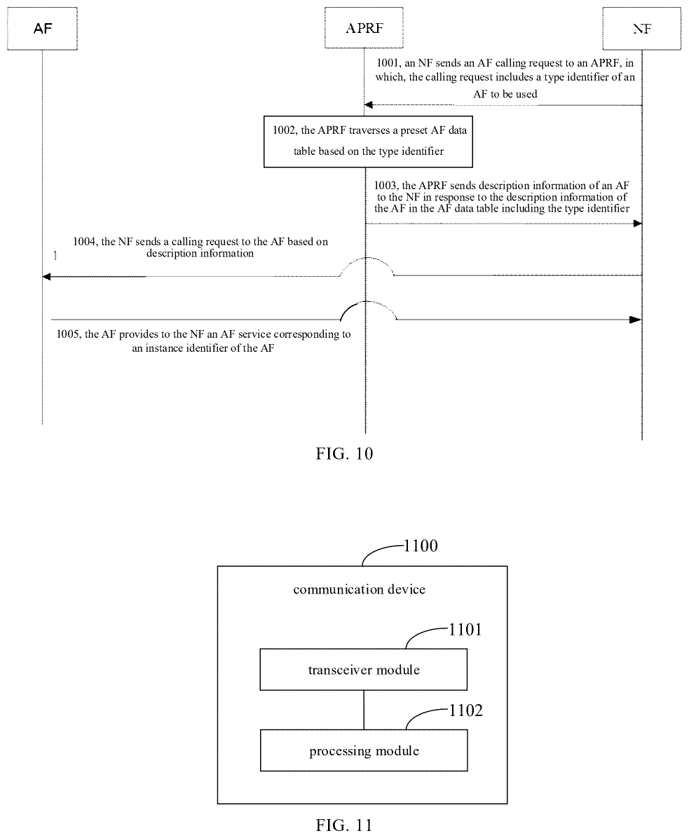

FIG. 10 is a schematic diagram of interaction of another application method for an application function provided by an example of the disclosure. As shown in FIG. 10, the method may include, but is not limited to, following steps.

At step 1001, an NF sends an AF calling request to an APRF, in which, the calling request includes a type identifier of an AF to be used.

At step 1002, the APRF traverses a preset AF data table based on the type

The AF data table stores description information of available AFs.

At step 1003, the APRF sends description information of an AF to the NF in response to the description information of the AF in the AF data table including the type identifier.

At step 1004, the NF sends a calling request to the AF based on description information.

The calling request includes an instance identifier of the AF to be used.

At step 1005, the AF provides to the NF an AF service corresponding to an instance identifier of the AF.

For a specific implementation process of each of the above steps, reference may be made to detailed description of any example of the present disclosure from FIG. 1 to FIG. 7, which will not be described again herein.

In this disclosure, the NF may send the AF calling request to the APRF, and then in a case of receiving the description information of the AF returned by the APRF, the NF may call the corresponding AF based on the description information. Therefore, the NF may reliably discover and use the AF, and performance of the communication system may be improved.

Please refer to FIG. 11, FIG. 11 is a schematic diagram of a communication device provided by an example of the disclosure. The communication device 1100 as illustrated in FIG. 11 may include a transceiver module 1101 and a processing module 1102. The transceiver module 1101 may include a transmitting module and/or a receiving module. The transmitting module is configured to implement a transmitting function, and the receiving module is configured to implement a receiving function. The transceiver module 1101 may implement the transmitting function and/or the receiving function.

It can be understood that the communication device 1100 may be an APRF, a device in the APRF, or a device that can be used in combination with the APRF.

For the communication device 1100, on the APRF side:
the transceiver module 1101 is configured to receive an application function (AF) calling request sent by a first network function (NF), in which, the calling request includes a first type identifier of an AF to be used; and
the processing module 1102 is configured to traverse a preset AF data table based on the first type identifier, in which, the AF data table stores description information of available AFs;
the transceiver module 1101 is further configured to send description information of a first AF to the first NF in response to the description information of the first AF in the AF data table comprising the first type identifier.

Optionally, the description information includes at least one of:
a type identifier, an instance identifier, a public land mobile network (PLMN) identifier, a network slice identifier, a network address or provided function service information of an AF.

Optionally, the transceiver module 1101 is further configured to receive a registration request sent by the first AF, in which, the registration request includes the description information of the first AF; and
the processing module 1102 is configured to store the description information of the first AF in the AF data table.

Optionally, the transceiver module 1101 is further configured to:
send indication information to respective NFs, in which, the indication information indicates that data in the AF data table has been changed.

Optionally, the transceiver module 1101 is further configured to:
return a registration response to the first AF, in which, the registration response indicates that registration of the first AF is completed.

Optionally, the transceiver module 1101 is further configured to:
return an AF calling failure indication to the first NF in response to description information of each AF in the AF data table not including the first type identifier.

Optionally, the transceiver module 1101 is further configured to: receive a deregistration request sent by a second AF, in which, the deregistration request includes an instance identifier and a deregistration cause of the second AF;
the processing module 1102 is further configured to traverse the preset AF data table based on the instance identifier of the second AF in response to the deregistration cause being legal;
processing module 1102 is further configured to delete description information comprising the instance identifier of the second AF in the preset AF data table; and
the transceiver module 1101 is further configured to return a deregistration response to the second AF, in which, the deregistration response indicates that the second AF is unavailable.

In this disclosure, after receiving the AF calling request sent by the first NF, the APRF first traverses the preset AF data table based on the first type identifier of the AF to be used, and sends the description information of the first AF to the first NF in a case of determining that the description information of the first AF in the data table includes the first type identifier,. Therefore, the NF can reliably discover and use the AF, and performance of a communication system may be improved.

It can be understood that the communication device 1100 may be an NF, a device in the NF, or a device that can be used in combination with the NF.

For the communication device 1100, on the NF side:
the transceiver module 1101 is configured to send an AF calling request to an APRF, in which, the calling request includes a first type identifier of an AF to be used;
the transceiver module 1101 is further configured to receive description information of a first AF sent by the APRF;
the transceiver module 1101 is further configured to send a calling request to the first AF based on description information of the first AF.

Optionally, the transceiver module 1101 is further configured to:
receive an AF calling failure indication sent by the APRF.

Optionally, the transceiver module 1101 is further configured to:
receive indication information sent by the APRF, in which, the indication information indicates that data in an AF data table in the APRF has been changed.

In this disclosure, the NF may send the AF calling request to the APRF, and send the calling request to the first AF based on the description information of the first AF after receiving the description information of the first AF sent by the APRF. Therefore, the NF can reliably discover and use the AF, and performance of a communication system may be improved.

It can be understood that the communication device 1100 may be an AF, a device in the NF, or a device that can be used in combination with the AF.

For the communication device 1100, on the AF side:
the transceiver module 1101 is configured to receive a calling request sent by an NF, in which, the calling request is generated by the NF based on description information of an AF sent by an APRF, and the calling request includes an instance identifier of an AF to be used; and
the processing module 1102 is configured to provide to the NF an AF service corresponding to an instance identifier of the AF.

Optionally, the transceiver module 1101 is further configured to:
send an AF change request to the APRF, in which, the change request includes the instance identifier of the AF.

Optionally, the change request is a registration request, and the registration request further includes a type identifier, a public land mobile network (PLMN) identifier, a network slice identifier, a network address and provided function service information of the AF; or
the change request is a deregistration request, and the deregistration request further includes a deregistration cause.

Optionally, the transceiver module 1101 is further configured to:
receive a change response returned by the APRF.

In this disclosure, the AF may provide to the NF the corresponding AF service based on the instance identifier of the AF in the request after receiving the application function calling request sent by the NF. Therefore, the NF can reliably discover and use the AF, and performance of a communication system may be improved.

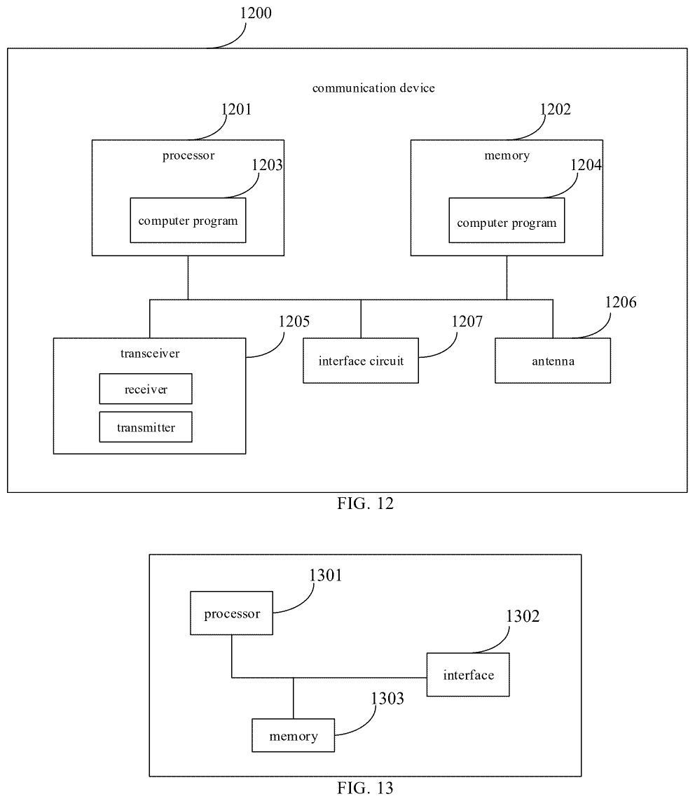

As illustrated in FIG. 12, FIG. 12 is a schematic diagram of another communication device 1200 provided by an example of the disclosure. The communication device 1200 may be an APRF, or may be an NF, or may be an AF, or may be a chip, a chip system or a processor that supports the APRF to realize the above-described methods, or may be a chip, a chip system or a processor that supports the NF to realize the above-described methods, or may be a chip, a chip system or a processor that supports the AF to realize the above-described methods. The device may be used to realize the methods described in the above method examples with reference to the description of the above-described method examples.

The communication device 1200 may include one or more processors 1201. The processor 1201 may be a general purpose processor or a dedicated processor, such as, a baseband processor and a central processor. The baseband processor is used for processing communication protocols and communication data. The central processor is used for controlling the communication device (e.g., a base station, a baseband chip, a terminal, a terminal chip, a central unit (CU), or a distributed unit (DU)), executing a computer program, and data of processing the computer program.

Optionally, the communication device 1200 may include one or more memories 1202 on which computer programs 1204 may be stored. The processor 1201 executes the computer programs 1204 to cause the communication device 1200 to perform the methods described in the above method examples. Optionally, the memory 1202 may also store data. The communication device 1200 and the memory 1202 may be provided separately or may be integrated together.

Optionally, the communication device 1200 may also include a transceiver 1205 and an antenna 1206. The transceiver 1205 may be referred to as a transceiver unit, a transceiver machine, or a transceiver circuit, for realizing a transceiver function. The transceiver 1205 may include a receiver and a transmitter. The receiver may be referred to as a receiving machine or a receiving circuit, for realizing the receiving function. The transmitter may be referred to as a transmitter machine or a transmitting circuit, for realizing the transmitting function.

Optionally, the communication device 1200 may also include one or more interface circuits 1207. The interface circuits 1207 are used to receive code instructions and transmit the code instructions to the processor 1201. The processor 1201 runs the code instructions to cause the communication device 1200 to perform the methods described in the method examples.

In a case that the communication device 1200 is an APRF, the processor 1201 executes step 202 in FIG. 2; step 302 in FIG. 3; steps 402-403 in FIG. 4. The transceiver 1205 executes steps 201 and 203 in FIG. 2; step 301 and 303 in FIG. 3; steps 401 and 404 in FIG. 4.

In a case that the communication device 1200 is an NF, the transceiver 1205 executes step 501-503 in FIG. 5, etc.

In a case that the communication device 1200 is an AF, the processor 1201 executes step 602 in FIG. 6. The transceiver 1205 executes step 601 in FIG. 6; steps 701-702 in FIG. 7, etc.

The communication device 1200 is a core network device, which can implement the methods shown in FIGS. 8 to 10.

In an implementation, the processor 1201 may include a transceiver for implementing the receiving and sending functions. The transceiver may be, for example, a transceiver circuit, an interface, or an interface circuit. The transceiver circuit, the interface, or the interface circuit for implementing the receiving and sending functions may be separated or may be integrated together. The transceiver circuit, the interface, or the interface circuit described above may be used for reading and writing code/data, or may be used for signal transmission or delivery.

In an implementation, the memory 1202 may store a computer program 1203. When the computer program 1203 runs on the processor 1201, the communication device 1200 is caused to perform the methods described in the method examples above. The computer program 1203 may be solidified in the processor 1201, and in such case the processor 1201 may be implemented by hardware.

In an implementation, the communication device 1200 may include circuits. The circuits may implement the sending, receiving or communicating function in the preceding method examples. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the description of the above examples may be a network device or a terminal, but the scope of the communication device described in the disclosure is not limited thereto, and the structure of the communication device may not be limited by FIG. 12. The communication device may be a stand-alone device or may be part of a larger device. For example, the described communication device may be:
(1) a stand-alone IC, a chip, a chip system or a subsystem;
(2) a collection of ICs including one or more ICs, optionally, the collection of ICs may also include storage components for storing data and computer programs;
(3) an ASIC, such as a modem;
(4) a module that can be embedded within other devices;
(5) a receiver, a terminal, a smart terminal, a cellular phone, a wireless device, a handheld machine, a mobile unit, an in-vehicle device, a network device, a cloud device, an AI device, and the like; and
(6) others.

The case that the communication device is a chip or a chip system can be referred to the schematic diagram of the chip shown in FIG. 13. The chip shown in FIG. 13 includes a processor 1301 and an interface 1302. There may be one or more processors 1301, and there are a plurality of interfaces 1302.

For a case where the chip is configured to implement functions of the APRF in an example of the present disclosure:

the interface 1302 is configured to execute steps 201 and 203 in FIG. 2, steps 301 and 303 in FIG. 3, steps 401 and 404 in FIG. 4, etc.

For a case where the chip is configured to implement functions of the NF in an example of the present disclosure:

the interface 1302 is configured to execute step 501, step 502, step 503, etc. in FIG. 5.

For a case where the chip is configured to implement functions of the AF in an example of the present disclosure:

the interface 1302 is configured to execute step 601 in FIG. 6, step 701 and step 702 in FIG. 7, etc.

Optionally, the chip further includes a memory 1303 for storing necessary computer programs and data.

It is understandable by those skilled in the art that various illustrative logical blocks and steps listed in the examples of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the examples of the disclosure.

The disclosure also provides a readable storage medium having instructions stored thereon. When the instructions are executed by a computer, the function of any of the method examples described above is implemented.

The disclosure also provides a computer program product. When the computer program product is executed by a computer, the function of any of the method examples described above is implemented.

The above examples may be implemented in whole or in part by software, hardware, firmware, or any combination thereof. When implemented using software, the above examples may be implemented, in whole or in part, in the form of a computer program product. The computer program product includes one or more computer programs. When loading and executing the computer program on the computer, all or part of processes or functions described in the examples of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs)) or wireless manner (e.g., using infrared wave, wireless wave, or microwave). The computer-readable storage medium may be any usable medium to which the computer is capable to access or a data storage device such as a server integrated by one or more usable mediums and a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the examples of the disclosure, or indicate the order of precedence.

The term “at least one” in the disclosure may also be described as one or more, and the term “multiple” may be two, three, four, or more, which is not limited in the disclosure. In the examples of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that may be understood by the communication device, and the values or representations of the parameters may be other values or representations that may be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, define in advance, store, pre-store, pre-negotiate, pre-configure, solidify, or pre-fire.

Those skilled in the art may realize that the units and algorithmic steps of the various examples described in combination with the examples disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method examples, and will not be repeated herein.

The above are only specific implementations of the disclosure, but the scope of protection of the disclosure is not limited thereto. Those skilled in the art familiar to this technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. An application method for an application function, comprising:
receiving, by an application repository function (APRF), an application function (AF) calling request sent by a first network function (NF), wherein the calling request comprises a first type identifier of an AF to be used;
traversing, by the APRF, a preset AF data table based on the first type identifier, wherein the AF data table stores description information of available AFs; and
sending, by the APRF, description information of a first AF to the first NF in response to the description information of the first AF in the AF data table comprising the first type identifier.

2. The method according to claim 1, wherein the description information comprises at least one of:
a type identifier, an instance identifier, a public land mobile network (PLMN) identifier, a network slice identifier, a network address or provided function service information of an AF.

3. The method according to claim 1, further comprising:
receiving a registration request sent by the first AF, wherein the registration request comprises the description information of the first AF; and
storing the description information of the first AF in the AF data table.

4. The method according to claim 3, further comprising:
sending indication information to respective NFs, wherein the indication information indicates that data in the AF data table has been changed.

5. The method according to claim 3, further comprising:
returning a registration response to the first AF, wherein the registration response indicates that registration of the first AF is completed.

6. The method according to claim 2, further comprising:
returning an AF calling failure indication to the first NF in response to description information of each AF in the AF data table not comprising the first type identifier.

7. The method according to claim 1, further comprising:
receiving a deregistration request sent by a second AF, wherein the deregistration request comprises an instance identifier and a deregistration cause of the second AF;
traversing the preset AF data table based on the instance identifier of the second AF in response to the deregistration cause being legal;
deleting description information comprising the instance identifier of the second AF in the preset AF data table; and
returning a deregistration response to the second AF, wherein the deregistration response indicates that the second AF is unavailable.

8. An application method of an application function, performed by a network function (NF), comprising:
sending an application function (AF) calling request to an application repository function (APRF), wherein the calling request comprises a first type identifier of an AF to be used;
receiving description information of a first AF sent by the APRF; and
sending a calling request to the first AF based on description information of the first AF.

9. The method according to claim 8, further comprising:
receiving an AF calling failure indication sent by the APRF.

10. The method according to claim 8, further comprising:
receiving indication information sent by the APRF, wherein the indication information indicates that data in an AF data table in the APRF has been changed.

11. An application method for an application function, performed by an application function (AF), comprising:
receiving a calling request sent by a network function (NF), wherein the calling request is generated by the NF based on description information of an AF sent by an application repository function (APRF), and the calling request comprises an instance identifier of an AF to be used; and
providing to the NF an AF service corresponding to an instance identifier of the AF.

12. The method according to claim 11, further comprising:
sending an AF change request to the APRF, wherein the change request comprises the instance identifier of the AF.

13. The method according to claim 12, wherein,
the change request is a registration request, and the registration request further comprises a type identifier, a public land mobile network (PLMN) identifier, a network slice identifier, a network address and provided function service information of the AF; or
the change request is a deregistration request, and the deregistration request further comprises a deregistration cause.

14. The method according to claim 12, further comprising:
receiving a change response returned by the APRF.

15. -20. (Canceled)

21. An application repository function (APRF) device, configured to perform the method as described in claim 1.

22. (canceled)

23. A non-transitory computer-readable storage medium for storing instructions, wherein, when the instructions are executed, the method as described in claim 1 is implemented.

24. A network function (NF), configured to perform the method as described in claim 8.

25. An application function (AF), configured to perform the method as described in claim 11.

26. A non-transitory computer-readable storage medium for storing instructions, wherein, when the instructions are executed, the method as described in claim 8 is implemented.

27. A non-transitory computer-readable storage medium for storing instructions, wherein, when the instructions are executed, the method as described in claim 11 is implemented.
